(19) United States
(12) Patent Application Publication
(10) Pub. No.: US 2024/0176991 A1
(43) Pub. Date: May 30, 2024

(54) METHOD FOR GENERATING CREATION USING EVOLUTION-BASED ARTIFICIAL INTELLIGENCE OBJECT CLUSTER

(71) Applicant: XOGAMES INC., Seongnam-si (KR)

(72) Inventor: Eui Joon YOUM, Seongnam-si (KR)

(21) Appl. No.: 18/500,096

(22) Filed: Nov. 1, 2023

Related U.S. Application Data
(63) Continuation of application No. PCT/KR2022/019179, filed on Nov. 30, 2022.

(30) Foreign Application Priority Data
Nov. 29, 2022 (KR) 10-2022-0163174

(51) Int. Cl. G06N 3/0455

(52) U.S. Cl. CPC G06N 3/0455

(57) ABSTRACT

An apparatus is disclosed for cultivating creativity through an evolution-inspired cluster of artificial intelligence (AI) objects. The apparatus encompasses multiple first-type AI objects, each meticulously trained and oriented to spawn distinct creations utilizing initial active inheritance information. Concomitantly, a multitude of second-type AI objects, informed by secondary active inheritance information, are adeptly conditioned to judiciously select from the array of generated creations. In culmination, a specialized creation providing unit seamlessly integrates the selections made by the second-type AI objects, provisioning a refined and meticulously evolved final creation, thus embodying a holistic convergence of innovation and evolutionary computing principles in the realm of artificial intelligence creativity.

### TECHNICAL FIELD

This document pertains to an apparatus designed to produce creative works using a cluster of artificial intelligence objects based on evolutionary principles. The present invention pertains to the generation and selection of creations using artificial intelligence (AI) entities. Specifically, the invention aims to produce a multitude of creations through first-type AI entities and subsequently select and finalize a creation via second-type AI entities. It should be noted that while the primary objectives of the invention are delineated herein, the scope of the invention is not limited thereto and may encompass other challenges not explicitly mentioned.

### BACKGROUND

For a long time, creative works were believed to be the domain of experts. However, recent advancements have shown that creations can now be generated using artificial intelligence models, such as generative adversarial networks (GANs) and large language models (LLMs).

Traditional AI models typically predict values for specific classes or estimate values within a range for continuous variables. For instance, GANs are primarily designed to generate distribution or dispersion data.

For content to gain popularity, it must strike a balance between aligning with current trends for relatability and showcasing unique originality for distinction. The secret to creating sought-after content lies in blending the familiar with the novel. Familiar elements can make content more accessible and relatable to a broad audience, while originality can make it stand out and be memorable.

However, gauging the potential influence of content on popular culture is challenging due to its subjective nature. There isn't a definitive metric for this. As a result, conventional AI models, which are designed to provide clear answers, struggle to produce content aimed at widespread appeal given these nuances and limitations. While AI can analyze patterns and data, the inherently unpredictable and subjective nature of human preferences can make it challenging for any current model to consistently predict cultural impact with high accuracy.

### PRIOR ART DOCUMENT

Patent Document 1: Korean Patent Laid-open Publication No. 2021-0052496 (published on May 10, 2021)

### DISCLOSURE OF THE INVENTION

### Summary of Invention

The present invention generally relates to artificial intelligence (AI), and more specifically, to a system and method for enhancing the generation and evolution of creative outputs through a hierarchical interplay of multiple artificial intelligence objects. The innovation lies in enabling artificial intelligence objects to produce, evolve, and optimize creations, with a specific emphasis on adaptability and responsiveness to prevailing trends and preferences. The present invention addresses not only the problems delineated herein but also various other challenges and obstacles which may not be explicitly mentioned.

Conventional AI approaches to creativity often deploy static algorithms and databases, generating outputs like music, art, or culinary recipes. Such traditional mechanisms exhibit rigidness, displaying limited dynamism and adaptability to fluctuating trends and preferences, which restricts their efficacy across diverse and evolving creative spectrums.

The present invention seeks to overcome the limitations of the prior art by introducing a sophisticated methodology involving a multitude of artificial intelligence objects. These objects operate hierarchically, wherein multiple first type artificial intelligence objects are geared towards the generation of creative outputs, and second type artificial intelligence objects focus on the evaluative and selective processes, ensuring the relevance, appeal, and originality of the generated creations.

One embodiment of the disclosed invention comprises an apparatus for facilitating the generation of a creation via an assembly of artificial intelligence objects that are architected and orchestrated in adherence to evolutionary methodologies. This apparatus encompasses multiple first-type artificial intelligence entities, each autonomously cultivated and optimized to yield disparate creations based on an initial set of active inheritance attributes. These entities generate a multitude of creative outputs, each a unique representation of the applied inheritance information.

In synergy with the first-type entities, the invention also incorporates a series of second-type artificial intelligence entities. These are meticulously trained to evaluate, discern, and selectively curate the creations, utilizing a distinct set of active inheritance parameters. This ensemble of second-type entities drives the decision-making process, funneling down the array of initial creations to a refined selection.

In a variant embodiment, the invention includes a mechanism dedicated to the procurement of the creations crafted by the first-type artificial intelligence entities. Supplementing this, an independent evaluation system, embodied as a vote-result generating component, is integrated, synthesizing the selections made by the second-type artificial intelligence entities. A specialized unit, termed the creation providing unit, is then tasked with delivering a conclusive creation, meticulously extracted and chosen from the aggregated pool of refined selections.

Central to the invention is the life setting of artificial intelligence objects, allowing for a dynamically evolving creative process. A predefined lifecycle ensures continuous innovation and adaptability, fostering an environment where creations are perpetually refined and optimized to resonate with current and future trends and preferences.

The invention contemplates a plurality of first type artificial intelligence objects, each imbued with distinct characteristics and attributes, focusing on generating diverse creative outputs. Concurrently, the second type of artificial intelligence objects operates evaluatively, applying selective pressures that drive the evolution and optimization of the creations. An intricate interplay between these AI objects, governed by a set of predetermined rules and parameters, facilitates a robust and dynamic creative ecosystem.

In conclusion, the invention presents a novel and advanced framework in the field of AI-driven creativity. By leveraging a hierarchical and evolutionary approach involving multiple artificial intelligence objects, the invention achieves a sophisticated, adaptable, and potent mechanism for generating, evolving, and optimizing a plethora of creative outputs, effectively navigating the complexities and demands of modern creative landscapes.

With the ingenuity embedded in the disclosed solutions, the invention stands poised to foster a dynamic multitude of creations, ingeniously generated through the orchestration of first-type artificial intelligence entities. By harnessing the evaluative prowess of the second-type artificial intelligence entities, the invention ensures the delivery of a meticulously curated final creation, embodying the evolutionary principles that underpin the invention's architecture.

### BRIEF DESCRIPTION OF THE DRAWINGS

FIG. 1 is a block diagram of a creation creating device according to an embodiment of the present disclosure.

FIG. 2 illustrates an evolution-based artificial intelligence object cluster according to an embodiment of the present disclosure.

FIG. 3 is provided to describe a method for training a plurality of first type artificial intelligence objects and a plurality of second type artificial intelligence objects according to an embodiment of the present disclosure.

FIG. 4 is a block diagram of a creation creating device according to another embodiment of the present disclosure.

FIG. 5 is a flowchart showing a method of generating a creation according to an embodiment of the present disclosure.

### BEST MODE FOR CARRYING OUT THE INVENTION

Hereinafter, embodiments of the present disclosure will be described in detail with reference to the accompanying drawings so that the present disclosure may be readily implemented by a person with ordinary skill in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Additionally, when a part “includes” one element, this means that it may further include another element rather than excluding another element, unless specifically stated to the contrary.

Through the whole document, the term “unit” includes a unit implemented by hardware, a unit implemented by software, and a unit implemented by both of them. One unit may be implemented by two or more pieces of hardware, and two or more units may be implemented by one piece of hardware.

Through the whole document, a part of an operation or function described as being carried out by a terminal or device may be carried out by a server connected to the terminal or device. Likewise, a part of an operation or function described as being carried out by a server may be carried out by a terminal or device connected to the server.

Hereinafter, the present disclosure will be explained in detail with reference to the accompanying configuration views or process flowcharts.

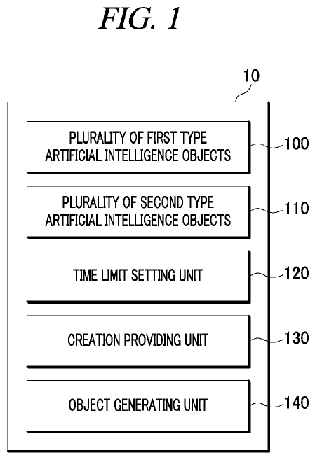

FIG. 1 is a block diagram of a creation creating device 10 according to an embodiment of the present disclosure.

Referring to FIG. 1, the creation creating device 10 may include a plurality of first type artificial intelligence objects 100, a plurality of second type artificial intelligence objects 110, a time limit setting unit 120, a creation providing unit 130, an object generating unit 140, a training unit 150, and a life setting unit 160. However, the creation creating device 10 illustrated in FIG. 1 is merely an embodiment of the present disclosure, and various modifications based on the components illustrated in FIG. 1 are possible.

In the present disclosure, the first type artificial intelligence objects 100 may be artificial intelligence objects with male propensity in the ecosystem, and the second type artificial intelligence objects 110 may be artificial intelligence objects with female propensity.

The first type artificial intelligence objects 100 with male propensity have a goal to be selected by as many second type artificial intelligence objects 110 as possible, and the second type artificial intelligence objects 110 with female propensity have a goal to select the first type artificial intelligence object 100 having a best attribute. In this way, a system in which the two types of artificial intelligence objects evolve while competing for their respective, conflicting goals can be implemented.

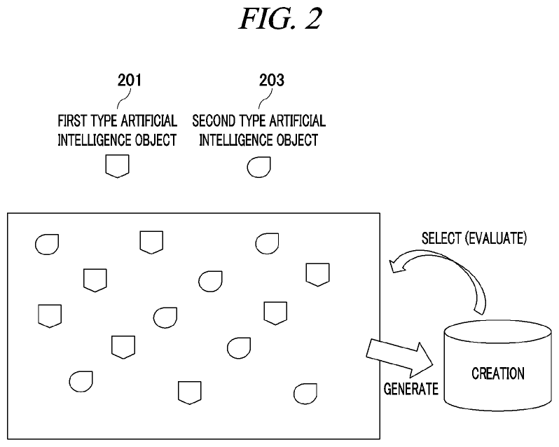

Hereinafter, the embodiment of FIG. 1 will be described with reference to FIG. 2.

The object generating unit 140 may generate the plurality of first type artificial intelligence objects 100 and the plurality of second type artificial intelligence objects 110 based on initial attribute information. Herein, the initial attribute information may be an initial value for generating the first type artificial intelligence object 100 that creates a creation and the second type artificial intelligence object 110 that selects the created creation. That is, the plurality of first type artificial intelligence objects 100 and the plurality of second type artificial intelligence objects 110 may have a plurality of genetic parameters which is initial attribute information as inheritable attribute values, and the genetic parameters may be a data set, such as a character string, a numeric string, a sequence, etc.

The initial attribute information may include attribute values previously set by a manager.

The plurality of first type artificial intelligence objects 100 and the plurality of second type artificial intelligence objects 110 are independent artificial intelligence objects having respective attributes and goals, and have genetic attribute information as attribute values which can be inherited to a next generation. Herein, the next generation refers to a descendent generation that inherits genetic factors.

The plurality of first type artificial intelligence objects 100 and the plurality of second type artificial intelligence objects 110 may be virtual objects operating in the creation creating device 10. For example, the plurality of first type artificial intelligence objects 100 and the plurality of second type artificial intelligence objects 110 may be objects that can evolve in parallel through replication. The plurality of first type artificial intelligence objects 100 and the plurality of second type artificial intelligence objects 110 may efficiently perform parallel replication based on long short-term memory capacity and computer power.

The plurality of first type artificial intelligence objects 100 has a goal to generate creations which can be selected by numerous second type artificial intelligence objects 203, and the plurality of second type artificial intelligence objects 110 has a goal to select a favorite creation from among the plurality of creations generated by the plurality of first type artificial intelligence objects 100.

For example, the object generating unit 140 may generate the plurality of first type artificial intelligence objects 100 and the plurality of second type artificial intelligence objects 110 based on verified initial attribute information. Herein, the verified initial attribute information may be an attribute value for generating content that satisfies a specific condition set by the user from among a plurality of attribute values derived through a simulation. Herein, the simulation refers to a process in which the first type artificial intelligence object 100 and the plurality of second type artificial intelligence objects 110 perform a combination of attributes a lot of times, and evolution may occur through the process of simulation.

For example, when there is not enough amount of verified initial attribute information used for generating the first type artificial intelligence object 100 and the second type artificial intelligence object 110, the object generating unit 140 may generate the plurality of first type artificial intelligence objects 100 and the plurality of second type artificial intelligence objects 110 based on a large amount of initial attribute information generated through random replication. Herein, the random replication refers to a method of randomly generating other attribute information similar to the verified initial attribute information.

For example, the object generating unit 140 may generate the plurality of first type artificial intelligence objects 100 and the plurality of second type artificial intelligence objects 110 based on initial attribute information set by the user.

The training unit 150 may train each of the generated plurality of first type artificial intelligence objects 100 and the generated plurality of second type artificial intelligence objects 110 based on the initial attribute information.

The training unit 150 may group the plurality of first type artificial intelligence objects 100 and the plurality of second type artificial intelligence objects 110 into a plurality of groups and train a plurality of first type artificial intelligence objects and a plurality of second type artificial intelligence objects so that a creation of a specific type can be generated and selected in each group. Herein, the specific type indicates a standard that classifies creations, and may include a genre of a creation, a technique of a creation, a feature of a creation, an origin of a creation, a philosophy in a creation, and the like.

For example, the training unit 150 may train a plurality of first type artificial intelligence objects included in a first group to generate a plurality of first similar creations corresponding to a first creation having popularity and a plurality of second type artificial intelligence objects included in the first group to select a first similar creation from among a plurality of creations.

The training unit 150 may train a plurality of first type artificial intelligence objects included in a second group to generate a plurality of second similar creations corresponding to a second creation of a specific genre and a plurality of second type artificial intelligence objects included in the second group to select a second similar creation of the specific genre from among a plurality of creations.

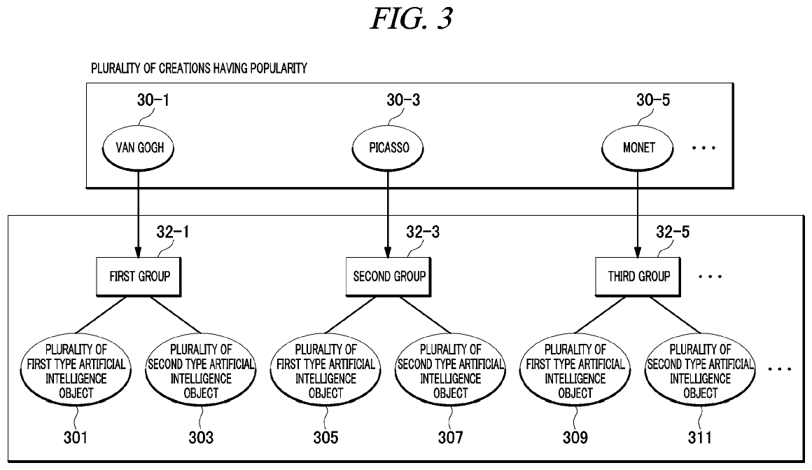

For example, referring to FIG. 3, a plurality of first type artificial intelligence objects 301 included in a first group 32-1 may be trained to generate a plurality of similar creations of Van Gogh style 30-1 and a plurality of second type artificial intelligence objects 303 included in the first group 32-1 may be trained to select a similar creation of Van Gogh style from among a plurality of creations including the similar creations of Van Gogh style and other creations.

For another example, a plurality of first type artificial intelligence objects 305 included in a second group 32-3 may be trained to generate a plurality of similar creations of modern art 30-3 and a plurality of second type artificial intelligence objects 307 included in the second group 32-3 may be trained to select a similar creation of modern art from among a plurality of creations including the similar creations of modern art and other creations.

A plurality of first type artificial intelligence objects 309 included in a third group 32-5 may be trained to generate a plurality of similar creations of impressionism 30-5 and a plurality of second type artificial intelligence objects 311 included in the third group 32-5 may be trained to select a similar creation of impressionism from among a plurality of creations including the similar creations of impressionism and other creations.

The time limit setting unit 120 may set a first time as a time limit for a plurality of first type artificial intelligence objects to generate creations and a second time as a time limit for a plurality of second type artificial intelligence objects to select creations. Herein, the first time may be shorter than the second time.

The plurality of first type artificial intelligence objects makes the best selection for creating creations by setting the first time to be shorter than the second time.

The plurality of second type artificial intelligence objects can select relatively the best creation by setting the second time to be longer than the first time.

Accordingly, the plurality of first type artificial intelligence objects generates a creation and the plurality of second type artificial intelligence objects sets a time limit to select a creation, and, thus, various creations can be generated and the artificial intelligence objects can evolve into various forms.

For example, the time limit setting unit 120 may adjust the first time and the second time based on the number of first type artificial intelligence objects and the number of second type artificial intelligence objects. For example, if the number of first type artificial intelligence objects is greater than the number of second type artificial intelligence objects, a time limit for the plurality of second type artificial intelligence objects to select a creation can be adjusted to be longer.

For example, if the number of first type artificial intelligence objects is smaller than a predetermined threshold value, the time limit setting unit 120 may adjust the time limit for the plurality of second type artificial intelligence objects to select a creation to be shorter.

Accordingly, if there are too many artificial intelligence objects, the artificial intelligence objects compete so hard as in the natural ecosystem, and, thus, the time limit may be lengthened to lessen competition. In order to suppress problems with activation in combination of attributes caused by too few artificial intelligence objects, counter balancing may be performed.

Meanwhile, the object generating unit 140 may determine a first type ancestor artificial intelligence object and a second type ancestor artificial intelligence object, which satisfy a predefined attribute combination condition, from among a plurality of first type ancestor artificial intelligence objects and a plurality of second type ancestor artificial intelligence objects, and generate the plurality of first type artificial intelligence objects 100 and the plurality of second type artificial intelligence objects 110 that inherit first active inheritance information of the first type ancestor artificial intelligence object, which satisfies the predefined attribute combination condition, and second active inheritance information of the second type ancestor artificial intelligence object, which satisfies the predefined attribute combination condition.

Herein, the predefined attribute combination condition may include a condition under which a first type ancestor artificial intelligence object as a trained ancestor artificial intelligence object can complete a learning process to generate a creation and a second type ancestor artificial intelligence object can complete a learning process to select a creation.

The predefined attribute combination condition may include a case where counterparts to be respectively combined with the first type ancestor artificial intelligence object and the second type ancestor artificial intelligence object are searched within a predetermined search range or the counterparts to be combined are not relevant to time limits (i.e., a time limit for a first type artificial intelligence object to generate a creation and a time limit for a second type artificial intelligence object to select a creation).

If the plurality of first type artificial intelligence objects 100 and the plurality of second type artificial intelligence objects 110 are generated by inheriting some of genetic attribute information of the plurality of first type ancestor artificial intelligence objects and the plurality of second type ancestor artificial intelligence objects, respectively, which are at higher inheritance levels, the plurality of first type artificial intelligence objects 100 and the plurality of second type artificial intelligence objects 110 may have the inherited genetic attribute information of the first type ancestor artificial intelligence objects and the second type ancestor artificial intelligence objects as well as their own genetic attribute information.

The plurality of first type artificial intelligence objects 100 and the plurality of second type artificial intelligence objects 110 may be generated by inheriting active inheritance information of the first type ancestor artificial intelligence object and the second ancestor artificial intelligence object, which satisfy the predefined attribute combination condition, from among the plurality of first type ancestor artificial intelligence objects and the plurality of second type ancestor artificial intelligence objects, respectively, which are at higher inheritance levels. Herein, the active inheritance information may include a ratio of inheritance information of at least one ancestor artificial intelligence object which is inherited by a descendent artificial intelligence object.

For example, if a first type artificial intelligence object has inheritance information of a parent artificial intelligence object, a grandparent artificial intelligence object and a great-grandparent artificial intelligence object, active inheritance information of the parent artificial intelligence object which is inherited by the first type artificial intelligence object may account for 10% of inheritance information of the parent artificial intelligence object, active inheritance information of the grandparent artificial intelligence object which is inherited by the first type artificial intelligence object may account for 5% of inheritance information of the grandparent artificial intelligence object, and active inheritance information of the great-grandparent artificial intelligence object which is inherited by the first type artificial intelligence object may account for 2.5% of inheritance information of the great-grandparent artificial intelligence object.

The plurality of first type artificial intelligence objects 100 may be trained to generate different creations, respectively, based on first active inheritance information of at least one first type ancestor artificial intelligence object and at least one second type ancestor artificial intelligence object and may generate a plurality of creations.

The plurality of second type artificial intelligence objects 110 may be trained to select at least one of a plurality of creations based on second active inheritance information of at least one first type ancestor artificial intelligence object and at least one second type ancestor artificial intelligence object and may select at least one of the plurality of creations created by the plurality of first type artificial intelligence objects 100.

Herein, the first active inheritance information and the second active inheritance information may be determined based on first genetic attribute information of at least one first type ancestor artificial intelligence object and second genetic attribute information of at least one second type ancestor artificial intelligence object.

Herein, the first genetic attribute information of the at least one first type ancestor artificial intelligence object may include parent genetic attribute information of a first type parent artificial intelligence object and grandparent genetic attribute information of a first type grandparent artificial intelligence object. In this case, the ratio of genetic attribute information of an ancestor artificial intelligence object which is inherited to a descendent artificial intelligence object may decrease as the distance between generations increases. For example, 50% of the parent genetic attribute information of the first type parent artificial intelligence object and 25% of the grandparent genetic attribute information of the first type grandparent artificial intelligence object may be genetically inherited to the plurality of first type artificial intelligence objects 100.

The second genetic attribute information of the at least one second type ancestor artificial intelligence object may include parent genetic attribute information of a second type parent artificial intelligence object and grandparent genetic attribute information of a second type grandparent artificial intelligence object. For example, 50% of the parent genetic attribute information of the second type parent artificial intelligence object and 25% of the grandparent genetic attribute information of the second type grandparent artificial intelligence object may be genetically inherited to the plurality of second type artificial intelligence objects 110.

The first genetic attribute information of the first type ancestor artificial intelligence object and the second genetic attribute information of the second type ancestor artificial intelligence object may include one of dominant attribute information that induces inheritance of genetic attribute information to a next generation and recessive attribute information that inhibits inheritance of genetic attribute information to a next generation. For example, when the dominant attribute information has an inheritance probability of 70%, the recessive attribute information may have an inheritance probability of 30%.

The life setting unit 160 may set a life for each of the plurality of first type artificial intelligence objects 100 and the plurality of second type artificial intelligence objects 110.

The life setting unit 160 may set a life of first type artificial intelligence objects (second type artificial intelligence objects) having the same characteristic to be shorter as the number of the first type artificial intelligence objects (second type artificial intelligence objects) having the same characteristic increases. For example, when 80% of the first type artificial intelligence objects has characteristic A, a life of the first type artificial intelligence objects having characteristic A may be set to decrease to 20% (⅕).

This is to keep continuous inheritance of genetic characteristics between generations while maintaining an appropriate life balance between the plurality of first type artificial intelligence objects 100 and the plurality of second type artificial intelligence objects 110.

The object generating unit 140 may determine a first type artificial intelligence object and a second type artificial intelligence object, which satisfy a predefined attribute combination condition, from among a plurality of first type artificial intelligence objects and a plurality of second type artificial intelligence objects, and generate a new artificial intelligence object that inherits first active inheritance information of the first type artificial intelligence object, which satisfies the predefined attribute combination condition, and second active inheritance information of the second type artificial intelligence object, which satisfies the predefined attribute combination condition.

Meanwhile, according to the present disclosure, it is possible to generate a new artificial intelligence object having a mutant attribute in order for a creation to have originality and distinction.

Specifically, the object generating unit 140 may generate a new artificial intelligence object having a mutant attribute with randomly selected genetic attribute information.

For example, the new artificial intelligence object having a mutant attribute may inherit the first active inheritance information of the first type artificial intelligence object, which satisfies the predefined attribute combination condition, and second modified active inheritance information generated by partially modifying the second active inheritance information of the second type artificial intelligence object. For example, the new artificial intelligence object having a mutant attribute may inherit first modified active inheritance information generated by partially modifying the first active inheritance information of the first type artificial intelligence object, which satisfies the predefined attribute combination condition, and the second active inheritance information of the second type artificial intelligence object, which satisfies the predefined attribute combination condition.

For example, the object generating unit 140 may generate a new artificial intelligence object that inherits at least one of first modified active inheritance information generated by partially modifying first active inheritance information of a randomly selected first type artificial intelligence object and second modified active inheritance information generated by partially modifying second active inheritance information of a randomly selected second type artificial intelligence object based on a predetermined mutation ratio (e.g., 20%).

For example, the object generating unit 140 may also generate a new artificial intelligence object having genetic attribute information that is irrelevant to first active inheritance information and second active inheritance information of a first type artificial intelligence object and a second type artificial intelligence object which are to be combined with each other.

The creation providing unit 130 may provide a final creation based on a plurality of creations selected by a plurality of second type artificial intelligence objects.

As described above, according to the present disclosure, it is possible to generate a creation the public might have empathy with and might like in various fields (e.g., paintings, music composition, cooking, etc.) by using the plurality of first type artificial intelligence objects 100 and the plurality of second type artificial intelligence objects 110.

For example, the plurality of first type artificial intelligence objects 100 may learn trend information of popular paintings and create a plurality of paintings, and the plurality of second type artificial intelligence objects 110 may select a painting the public might want to buy most from among the plurality of paintings created by the plurality of first type artificial intelligence objects 100.

For example, the plurality of first type artificial intelligence objects 100 may learn attribute information of consistently popular music and new attributes and compose a lot of music, and the plurality of second type artificial intelligence objects 110 may select music the public might be familiar with from among a lot of music composed by the plurality of first type artificial intelligence objects 100.

For example, the plurality of first type artificial intelligence objects 100 may learn new cooking recipes and cooking methods as well as existing cooking recipes and cooking methods and create new forms of cooking methods (e.g., Korean-style Chinese food). The plurality of second type artificial intelligence objects 110 may select a food with popular taste from among a plurality of foods created by the plurality of first type artificial intelligence objects 100 based on elements of taste (e.g., salty, sour, bitter, sweet, umami, etc.) and temperature factors.

Meanwhile, it would be understood by a person with ordinary skill in the art that each of the plurality of first type artificial intelligence objects 100, the plurality of second type artificial intelligence objects 110, the time limit setting unit 120, the creation providing unit 130, the object generating unit 140 the training unit 150, and the life setting unit 160 can be implemented separately or in combination with one another.

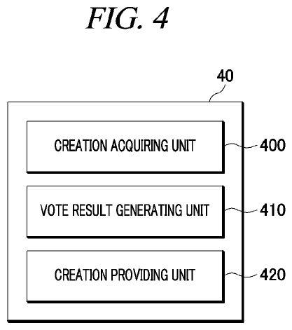

FIG. 4 is a block diagram of a creation creating device 40 according to another embodiment of the present disclosure.

Referring to FIG. 4, the creation creating device 40 may include a creation acquiring unit 400, a vote result generating unit 410, and a creation providing unit 420. However, the creation creating device 40 illustrated in FIG. 4 is merely an embodiment of the present disclosure, and various modifications based on the components illustrated in FIG. 4 are possible.

According to another embodiment, a plurality of first type artificial intelligence objects and a plurality of second type artificial intelligence objects may be generated and managed by a separate artificial intelligence object generating device, and the creation creating device 40 may generate and select a creation by communication with the artificial intelligence object generating device.

Herein, the plurality of first type artificial intelligence objects is trained with a goal to generate creations which can be selected by numerous second type artificial intelligence objects, and the plurality of second type artificial intelligence objects is trained with a goal to select (evaluate) the plurality of creations generated by the plurality of first type artificial intelligence objects.

Specifically, the creation acquiring unit 400 may receive creation information from the artificial intelligence object generating device.

The creation acquiring unit 400 may acquire, from the artificial intelligence object generating device, a plurality of creations generated by the plurality of first type artificial intelligence objects, respectively.

The creation acquiring unit 400 may receive, from the artificial intelligence object generating device, a result of selecting at least one of the plurality of creations, which is generated by the plurality of first type artificial intelligence objects, by the plurality of second type artificial intelligence objects, respectively.

The vote result generating unit 410 may generate a vote result based on the received result of selection by the plurality of second type artificial intelligence objects.

The vote result generating unit 410 may generate a vote result for the plurality of creations selected by the plurality of second type artificial intelligence objects, respectively.

The creation providing unit 420 may provide a final creation from among the generated plurality of creations based on the vote result.

For example, the creation providing unit 420 may select a creation receiving the most votes as a final creation based on the vote result for the plurality of creations and provide the final creation to the user.

Meanwhile, it would be understood by a person with ordinary skill in the art that each of the creation acquiring unit 400, the vote result generating unit 410, and the creation providing unit 420 can be implemented separately or in combination with one another.

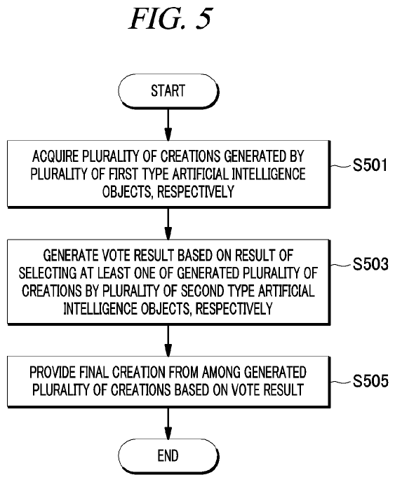

FIG. 5 is a flowchart showing a method of generating a creation according to an embodiment of the present disclosure.

Referring to FIG. 5, the creation creating device 40 may acquire a plurality of creations generated by a plurality of first type artificial intelligence objects, respectively, in a process S501. Herein, the plurality of first type artificial intelligence objects may be trained to generate different creations, respectively, based on first active inheritance information and may generate a plurality of creations. Herein, the first active inheritance information may be determined based on first genetic attribute information of at least one first type ancestor artificial intelligence object, which is at a higher inheritance level, and second genetic attribute information of at least one second type ancestor artificial intelligence object, which is at a higher inheritance level.

In a process S503, the creation creating device 40 may generate a vote result based on a result of selecting at least one of the generated plurality of creations by the plurality of second type artificial intelligence objects, respectively. Herein, the plurality of second type artificial intelligence objects may be trained to select at least one of a plurality of creations based on second active inheritance information and may select at least one of the plurality of creations. Herein, the second active inheritance information may be determined based on first genetic attribute information of at least one first type ancestor artificial intelligence object, which is at a higher inheritance level, and second genetic attribute information of at least one second type ancestor artificial intelligence object, which is at a higher inheritance level.

In a process S505, the creation creating device 40 may provide a final creation from among the generated plurality of creations based on the vote result.

In the descriptions above, the processes S501 to S505 may be divided into additional processes or combined into fewer processes depending on an embodiment. In addition, some of the processes may be omitted and the sequence of the processes may be changed if necessary.

The embodiment of the present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage media. The computer storage media include all volatile/non-volatile and removable/non-removable media embodied by a certain method or technology for storing information such as computer-readable instruction code, a data structure, a program module or other data.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. An apparatus for generating a creation using an evolution-based artificial intelligence object cluster, comprising:
a plurality of first type artificial intelligence objects configured to be trained to generate different creations, respectively, based on first active inheritance information and generate a plurality of creations;
a plurality of second type artificial intelligence objects configured to be trained to select at least one of the plurality of creations based on second active inheritance information and select at least one of the plurality of creations; and
a creation providing unit configured to provide a final creation based on a plurality of creations selected by the plurality of second type artificial intelligence objects.

2. The apparatus of claim 1,
wherein the plurality of first type artificial intelligence objects and the plurality of second type artificial intelligence objects are generated by inheriting active inheritance information of a first type ancestor artificial intelligence object and a second ancestor artificial intelligence object, which satisfy a predefined attribute combination condition, from among a plurality of first type ancestor artificial intelligence objects and a plurality of second type ancestor artificial intelligence objects, respectively, which are at higher inheritance levels.

3. The apparatus of claim 2,
wherein the first active inheritance information and the second active inheritance information are determined based on first genetic attribute information of at least one first type ancestor artificial intelligence object and second genetic attribute information of at least one second type ancestor artificial intelligence object.

4. The apparatus of claim 3,
wherein the first genetic attribute information includes parent genetic attribute information of a first type parent artificial intelligence object and grandparent genetic attribute information of a first type grandparent artificial intelligence object, and
the second genetic attribute information includes parent genetic attribute information of a second type parent artificial intelligence object and grandparent genetic attribute information of a second type grandparent artificial intelligence object.

5. The apparatus of claim 3,
wherein the first genetic attribute information and the second genetic attribute information include one of dominant attribute information that induces inheritance of genetic attribute information to a next generation and recessive attribute information that inhibits inheritance of genetic attribute information to a next generation.

6. The apparatus of claim 1,
wherein, among a plurality of first type artificial intelligence objects and a plurality of second type artificial intelligence objects generated based on initial attribute information, a plurality of first type artificial intelligence objects included in a first group is trained to generate a first similar creation corresponding to a first creation having popularity, and a plurality of second type artificial intelligence objects included in the first group is trained to select the first similar creation from among a plurality of creations, and
a plurality of first type artificial intelligence objects included in a second group is trained to generate a second similar creation corresponding to a second creation having popularity, and a plurality of second type artificial intelligence objects included in the second group is trained to select the second similar creation from among a plurality of creations.

7. The apparatus of claim 1, further comprising:
a time limit setting unit configured to set a first time for the plurality of first type artificial intelligence objects to generate the creations and a second time for the plurality of second type artificial intelligence objects to select the creations,
wherein the first time is shorter than the second time.

8. The apparatus of claim 7, further comprising:
an object generating unit configured to determine a first type artificial intelligence object and a second type artificial intelligence object, which satisfy a predefined attribute combination condition, from among the plurality of first type artificial intelligence objects and the plurality of second type artificial intelligence objects, and generate a new artificial intelligence object that inherits first active inheritance information of the first type artificial intelligence object, which satisfies the predefined attribute combination condition, and second active inheritance information of the second type artificial intelligence object, which satisfies the predefined attribute combination condition.

9. The apparatus of claim 8,
wherein the object generating unit is configured to enable the new artificial intelligence object to inherit at least one of the first active inheritance information and the second active inheritance information, which are randomly selected.

10. The apparatus of claim 1,
wherein a life is set for each of the plurality of first type artificial intelligence objects and the plurality of second type artificial intelligence objects.

11. An apparatus for generating a creation using an evolution-based artificial intelligence object cluster, comprising:
a creation acquiring unit configured to acquire a plurality of creations generated by a plurality of first type artificial intelligence objects, respectively;
a vote result generating unit configured to generate a vote result based on a result of selecting at least one of the generated plurality of creations by a plurality of second type artificial intelligence objects, respectively; and
a creation providing unit configured to provide a final creation from among the generated plurality of creations based on the vote result,
wherein each of the plurality of first type artificial intelligence objects is trained to generate different creations, respectively, based on first active inheritance information and generates the plurality of creations, and
the plurality of second type artificial intelligence objects is trained to select at least one of the plurality of creations based on second active inheritance information and selects at least one of the plurality of creations.
